(19) United States
(12) Patent Application Publication
(10) Pub. No.: US 2002/0064290 A1
(43) Pub. Date: May 30, 2002

(54) Display systems

(75) Inventors: David Reynaga, Cambs (GB); Henry Azima, Cambridge (GB)

Correspondence Address: FOLEY AND LARDNER, SUITE 500, 3000 K STREET NW, WASHINGTON, DC, 20007, US

(73) Assignee: NEW TRANSDUCERS LIMITED

(21) Appl. No.: 09/993,883

(22) Filed: Nov. 27, 2001

Related U.S. Application Data
(60) Provisional application No. 60/253,080, filed on Nov. 28, 2000.

(30) Foreign Application Priority Data
Nov. 28, 2000 (GB) 0029082.5

(51) Int. Cl. H04R 23/00

(52) U.S. Cl. 381/152; 381/337

(57) ABSTRACT

A loudspeaker/visual display combination comprises a visual display module and a transducer attached to the display module to apply bending wave energy thereto to cause the display module to radiate an acoustic output. Attachment of a transducer directly to the visual display module dispenses with the need for a separate bending wave speaker whilst application of bending wave energy to the module allows satisfactory acoustic performance to be obtained.

This application claims the benefit of provisional application No. 60/253,080, filed Nov. 28, 2000.

### FIELD OF THE INVENTION

The invention relates to display systems, in particular a combination loudspeaker and visual display device.

### BACKGROUND

A specification can be derived for such a product in most applications where the display is relatively proximate to the observer. In such cases the display system is of a more personal nature than a conventional loudspeaker, where it is expected that a larger number of persons need to be served with sound at significant distances, from 1 to 5 m for example. Whereas such a conventional speaker may be routinely specified having 1 W input measured at 1 m, e.g. 82 to 88 dB of sound level, for a personal speaker the required maximum sound level is less due to the fact that proximity, e.g. to 0.5 m or less, doubles the effective sound level reading. Noting that in any case the very small “micro speakers” fitted to such displays, e.g. in lap top computers, are quite inefficient, of about 65 dB/W, the design criteria for a combination display screen and speaker are not as strict as those for conventional speakers. In the case of a portable computer, pleasant “conversation level” sound intensities may be generated by a sensitivity of 70 dB at 0.5 m.

US2001/0026625A1 (incorporated herein by reference) discloses a combination loudspeaker and visual display device comprising a transparent bending wave speaker spaced from the front of a display screen by a small spacing air layer. Such a speaker requires a marginal region to allow placement of the excitation means outside of the display area where they would otherwise obstruct the image.

JP 62 203 132 discloses a combination buzzer and visual display device. A ferroelectric liquid crystal display is used, the pulse frequency of the AC bias driving waveform being chosen so as to generate sound of a desired frequency. Although simpler in construction than the device of WO00/02417, the quality of sound is very much lower and suitable only for use as a buzzer.

### SUMMARY OF THE INVENTION

The present invention has as an objective a combination loudspeaker and visual display device having simple construction together with improved audio performance.

Accordingly, the invention consists in a loudspeaker/visual display combination comprising a visual display module and a transducer attached to the display module to apply bending wave energy thereto to cause the display module to radiate an acoustic output.

Attachment of a transducer directly to the visual display module dispenses with the need for a separate bending wave speaker. Furthermore, application of bending wave energy to the module allows satisfactory acoustic performance to be obtained as known, e.g. from WO 97/09842 and its US counterpart (U.S. application Ser. No. 08/707,012, filed Sep. 3, 1996, which is incorporated herein by reference).

The visual display module is advantageously a liquid crystal display device and may have attached to its rear surface and/or its inactive periphery a transducer of the grounded or inertial variety. Bending may be excited in the transverse plane of the display module, which is preferably analysed for its available modal distribution and the transducer positioned to achieve coupling to the modal distribution for sound excitation over the chosen frequency range. To provide consistent and predictable bending wave action, the device may be constructed such that several layers are coupled using optically compatible adhesives or adhesive films selected. In addition, the visual display module may be sealed and maintained at a level of negative atmospheric pressure so as to achieve closer coupling of the layers.

Further advantageous features of the invention are set out in the following description.

### BRIEF DESCRIPTION OF THE DRAWING

Examples that disclose the best mode for carrying out the invention are described in detail below with reference to the accompanying drawing, in which:

FIG. 1 is a schematic cross-sectional view of a first embodiment of a combination display screen/loudspeaker in accordance with the invention;

FIG. 2 is a schematic cross-sectional view of a second embodiment of a combination display screen/loudspeaker;

FIG. 3 is a schematic cross-sectional view of a third embodiment of a combination display screen/loudspeaker; and

FIG. 4 is a detail view of the encircled portion of FIG. 3.

### DETAILED DESCRIPTION

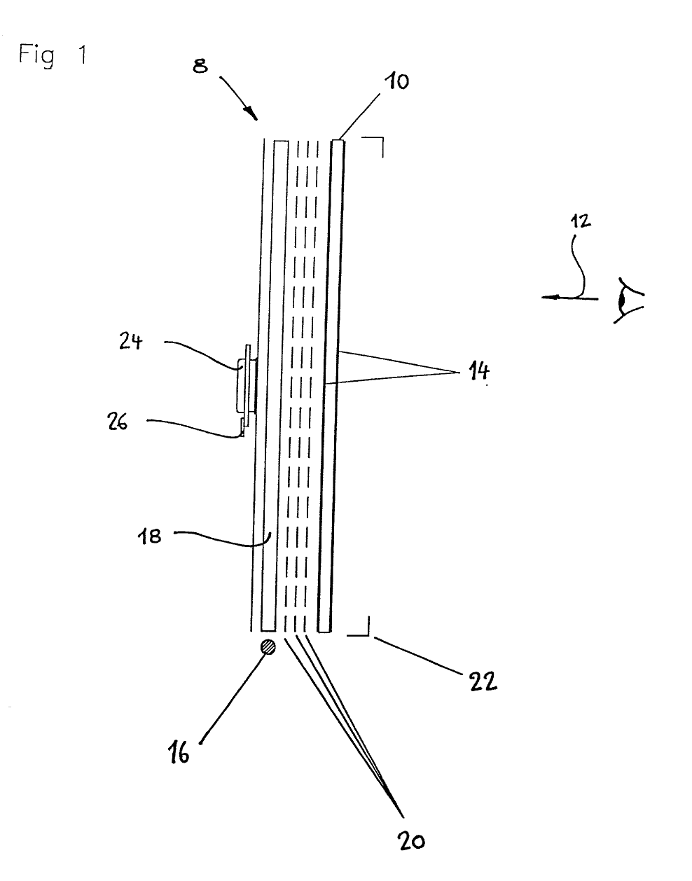

Referring to FIG. 1, there is shown a combination loudspeaker and visual display assembly 8 comprising a liquid crystal display (LCD) module 10 composed of LCD films sandwiched between two layers of thin glass each typically 0.5 mm thick. This is a sealed unit and is the dominant part in terms of bending stiffness for the assembly. Typical dimensions of such units are height 184-198 mm, breadth 224-268 mm, thickness 4 mm and weight 0.3 kg.

In front of module 10 (as seen from the direction of viewing indicated at 12) may be positioned polarising filters of thin polymer and an anti-reflection coating 14, together with an outer metal frame 22. Behind is a backlight illumination section comprising a cold cathode light 16, a light diffuser 18 and brightness enhancement films 20. The latter may compose thin, relatively compliant plastic sheets separated by thin air films.

Bonded by means of adhesive to the rear of the backlight illumination section 16, 18, 20 is an electromagnetic, inertial exciter 24. Such exciters are well known in the art, e.g. from U.S. Pat. No. 6,192,136, U.S. application Ser. No. 09/355,312 (filed Jan. 30, 1998) and U.S. application Ser. No. 09/518,820 (filed Mar. 3, 2000), all incorporated herein by reference.

Application of a suitable electrical audio signal to connection 26 will actuate the exciter which will in turn excite bending in the transverse plane of the assembly, causing this to operate as a bending wave loudspeaker. This is unexpected because, prior to this invention, the multi-layered construction of known complete LCD display modules as described above would have been viewed as unpromising in terms of their use as bending wave speaker panels. In particular, it has been found that, although the multi-layer construction of a visual display module may load and damp its potential bending action to a moderate degree, it does not prevent bending wave propagation so much that useful sound energy is not radiated. Typical performance values are a mean sensitivity of 65 dB for 1 W at 1M and bandwidth of around 400 Hz to 9.8 Hz (+/− 3 dB from mean). As regards sound quality, it has been found that at frequencies within the useful operating range of the panel and for sensible power inputs, e.g. up to a few watts of electrical input, the invention is free from audible distortion or rattles.

For a display module having the typical parameters listed above, a 19 mm diameter inertial exciter of the kind manufactured, for example, by Tianle has provided satisfactory performance. However, so-called “grounded” exciters may be used instead: as is well known, such exciters have a “ground” connection to the supporting structure of the assembly which supports the reaction force exerted by the assembly 8 against the exciter.

As shown in FIG. 1, the exciter is preferably mounted at the rear of the assembly 8 where it is concealed from view, leaving the display area unobstructed. However, it is also feasible to mount the exciter at the front, either by itself or in combination with a rear-mounted exciter.

In a preferred embodiment, the available modal distribution of the module is analysed and exciter position(s) selected for designed coupling to the modal distribution for sound excitation over the chosen frequency range, e.g. as described in WO97/09842 and U.S. application Ser. No. 08/707,012, thereby optimising the bandwidth and sensitivity. For a rectangular screen, a typical excitation position may be found at a point located 4/9 along one side and 3/7 along another side perpendicular thereto.

Advantageously, the assembly is constructed to be free of rattles so as to optimise the performance for acoustic and display purposes. Further improvements may include the use or choice of optically compatible adhesives or adhesive films to couple more closely the various layers comprising the module for more consistent and predictable bending wave action. The module may also be sealed and operated at some level of negative atmospheric pressure to more closely couple the constituent layers. The use of lighter materials in the construction around the LCD layer could also improve sensitivity. Acoustic performance may be improved yet further by the use of conventional measures e.g. rear enclosures per the aforementioned WO97/09842 and U.S. Ser. No. 08/707,012.

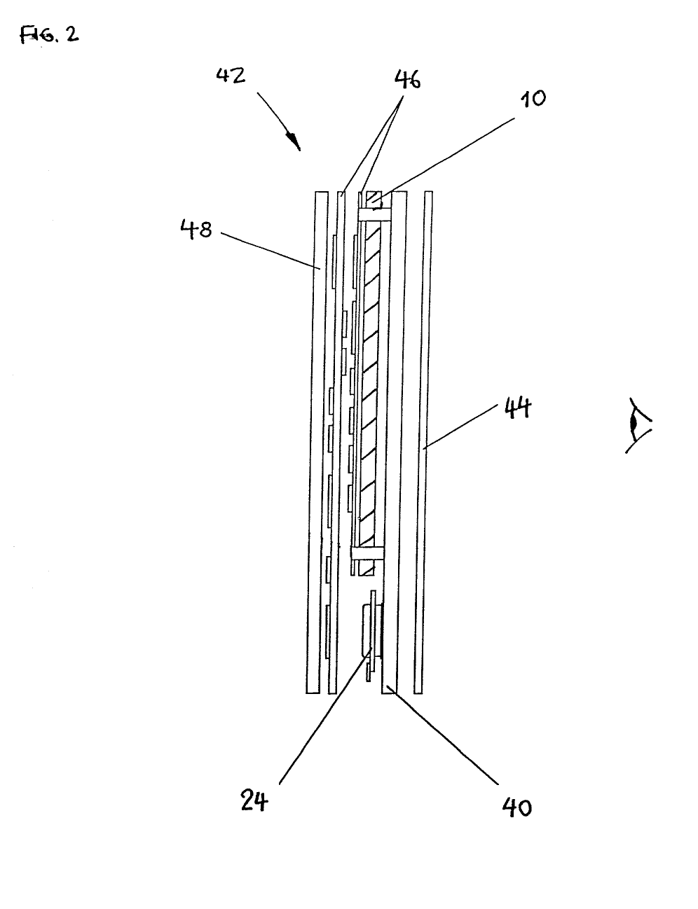

FIG. 2 shows a second embodiment of the present invention. In addition to an LCD module 10, the assembly 42 incorporates a touch-sensor 40 and associated circuitry 46, making it suitable for use in personal digital assistant (PDA) devices and the like. To the rear of the sensor 40 is attached an exciter 24 which, given the smaller dimensions of an LCD module required for a PDA (typically 72 mm×91 mm×2.5 mm), has a smaller diameter of 11 mm. Bounding the assembly is a clear frame panel 44 at the front and a clear acrylic panel 48 at the back. Further improvements as described with regard to the first embodiment, particularly lighter materials for the touch screen, may improve performance yet further.

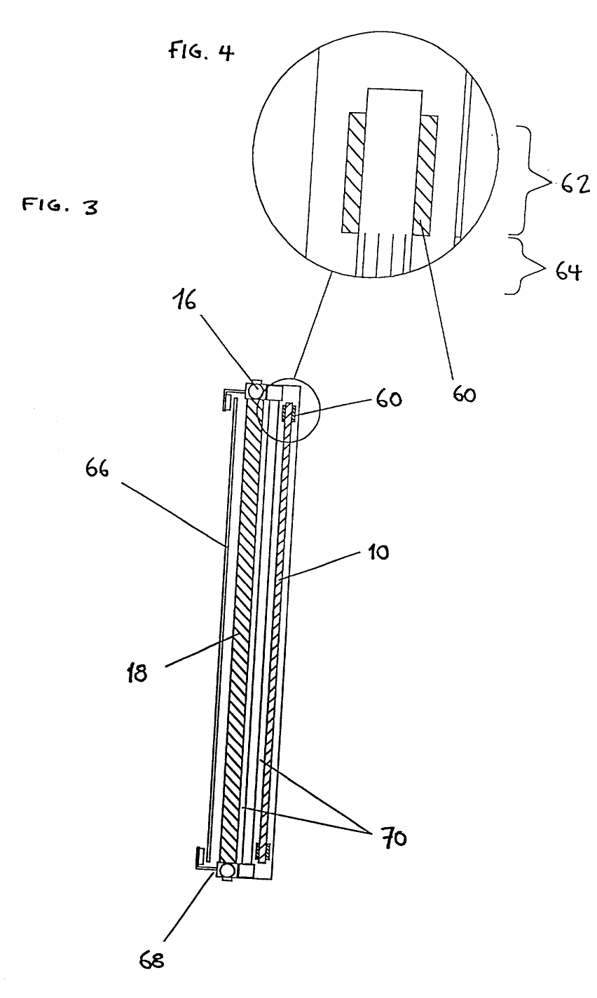

It will be appreciated that, instead of the electromagnetic exciters described above, other kinds of exciter—including electrodynamic and piezoelectric—may be used. FIG. 3 shows an embodiment of the invention using piezoelectric exciters 60 mounted at the periphery of an LCD module 10. As shown in greater detail in FIG. 4, the exciters 60 extend only over the visually inactive periphery 62 of the screen, leaving the active display area 64 unobstructed. As in the first embodiment, a cold cathode light source 16 and light conduit/diffuser 18 are mounted at the rear of the assembly which, in the example shown, also includes a reflector 66 that may allow non-backlit operation of the display. A plastic enclosure 68 may help maintain appropriate air gaps 70 between the various elements of the display.

It should be understood that this invention has been described by way of examples only and that a wide variety of modifications can be made without departing from the scope of the invention as described in the accompanying claims. In particular, the invention is not restricted in the type of display to which it may be applied: although described in the context of a simple LCD device, active LCD devices incorporating thin film transistors (TFTs) as well as displays working according to other, e.g. emissive, principles are possible.

1. A combination loudspeaker visual display device, comprising a visual display module and a transducer attached to the display module to apply bending wave energy thereto to cause the display module to radiate an acoustic output.

2. A combination loudspeaker and visual display device according to claim 1, wherein the visual display module is a liquid crystal display device.

3. A combination loudspeaker and visual display device according to claim 1 or claim 2, wherein the transducer is grounded.

4. A combination loudspeaker and visual display device according to claim 1 or claim 2, wherein the transducer is an inertial transducer.

5. A combination loudspeaker and visual display device according to claim 1 or claim 2, wherein the transducer is adapted to excite bending in the transverse plane of the display module.

6. A combination loudspeaker and visual display device according to claim 1 or claim 2, wherein the visual display module is analysed for its available modal distribution and a transducer position is selected for designed coupling to the modal distribution for sound excitation over the chosen frequency range.

7. A combination loudspeaker and visual display device according to claim 1 or claim 2, wherein the visual display module comprises several layers which are coupled using optically compatible adhesives or adhesive films selected to provide consistent and predictable bending wave action.

8. A combination loudspeaker and visual display device according to claim 7, wherein the visual display module is sealed and maintained at a level of negative atmospheric pressure, whereby the layers are more closely coupled.

9. A combination loudspeaker and visual display device according to claim 1 or claim 2, wherein the transducer is attached to the rear of the visual display module.

10. A combination loudspeaker and visual display device according to claim 1 or claim 2, wherein the transducer is attached to the inactive periphery of the visual display module.
